(19) United States
(12) Patent Application Publication
(10) Pub. No.: US 2012/0031495 A1
(43) Pub. Date: Feb. 9, 2012

(54) Thermoplastic Polymeric Composition with Improved Resistance to Thermo-Oxidative Degradation and Use Thereof for Producing Pipes

(75) Inventors: Heinz Vogt, Frankfurt (DE); Hansjörg Nitz, Frankfurt (DE)

(73) Assignee: Basell Polyolefine GmbH, Wesseling (DE)

(21) Appl. No.: 13/264,152

(22) PCT Filed: Apr. 23, 2010
(86) PCT No.: PCT/EP2010/002494

§ 371 Date: Oct. 28, 2011

Related U.S. Application Data
(60) Provisional application No. 61/217,924, filed on Jun. 5, 2009.

(30) Foreign Application Priority Data
Apr. 29, 2009 (DE) 10 2009 019 11.0

(51) Int. Cl. F15D 1/00; B32B 1/08; B29C 47/20; C08K 5/3437; C08K 5/18

(52) U.S. Cl. 137/1; 524/87; 524/254; 264/209.1; 428/36.9

(57) ABSTRACT

A polyolefinic moulding composition is suitable for producing pipes with improved resistance to thermo-oxidative degradation when these pipes are in extended contact with liquids which contain disinfectants with an oxidative action. Beside thermoplastic polyolefins, the moulding composition additionally contains specific aromatic amines which are liquid under standard conditions as an additive. The invention also relates to a pipe made from the moulding composition and to a process for improving the long-term resistance of water pipework made of plastics to damage by disinfectants with an oxidative action from the water by the use of this moulding composition.

This application is the U.S. national phase of International Application PCT/EP2010/002494, filed Apr. 23, 2010, claiming priority to German Patent Application 10 2009 019 11.0 filed Apr. 29, 2009 and the benefit under 35 U.S.C. 119(e) of U.S. Provisional Application No. 61/217,924, filed Jun. 5, 2009; the disclosures of International Application PCT/EP2010/002494, German Patent Application 10 2009 019 11.0 and U.S. Provisional Application No. 61/217,924, each as filed, are incorporated herein by reference.

The present invention relates to a thermoplastic polyolefinic moulding composition with improved resistance to thermo-oxidative degradation. The moulding composition is in particular suitable for producing pipes which are in extended contact with liquids which contain disinfectants with an oxidative action.

Moulding compositions of polyethylene (PE), polypropylene (PP) and polybutene-1 (PB-1) have for many years been used for producing plastics pipes for distributing hot and cold water in buildings (see EP 739 937).

While pipes made from the stated plastics do indeed have very good resistance to water, it has been found that their service life is severely limited if the pipes come into contact with conventional disinfectants which are often added to the water for reasons of hygiene. Small amounts of substances with an oxidative action such as chlorine gas, sodium hypochlorite (chlorine bleach solution), calcium hypochlorite or chlorine dioxide are in fact generally added as a disinfectant to municipal drinking water, while hydrogen peroxide (H₂O₂) or ozone (O₃) are also occasionally used.

The polyethylene pipes may here be uncrosslinked or crosslinked. Crosslinking may here proceed by the conventional crosslinking processes used industrially by means of organic peroxides, grafted vinylsilane esters or by means of high-energy radiation (γ or β radiation).

The object of the present invention was accordingly to provide a novel moulding composition based on PE, PP or PB-1 which, while retaining good processability into pipes with regard to their use for drinking water which contains disinfectants with an oxidative action, exhibits improved resistance, in particular over an extended period of time.

This object is achieved by a polyolefinic moulding composition, the characterizing feature of which should be considered to be that it contains a thermoplastic polyolefin and an amount of 0.01 to 1.0 wt. %, calculated on the total weight of the moulding composition, of an aromatic amine which is liquid under standard pressure and in the temperature range from 0 to 30° C.

WO 03/064511 has already disclosed a polyolefin such as PE or PP which, in order to improve its resistance to chlorine, contains a stabilizer combination of an organotin compound and NH-containing substances.

The moulding composition according to the invention differs from the prior art by the selection of specific liquid amines from among the many known amino compounds, which specific liquid amines, even in the absence of tin compounds hitherto considered necessary, particularly surprisingly impart good stability to pipes made from the moulding composition against the oxidative action of the disinfectants in the water over an extended period of time.

6-Ethoxy-2,2,4-trimethyl-1,2-dihydroquinoline and dimethylphenylenediamine have proved to be particularly suitable aromatic amines. The preferred amounts in which these aromatic amines are used are in the range from 0.01 to 0.5 wt. %, particularly preferably from 0.1 to 0.3 wt. %.

In one particular embodiment of the invention, further stabilizers of a conventional type, such as IRGANOX 1010 or IRGAPHOS 168, may additionally be added to the moulding composition. The chemical name for Irganox 1010 is 3-(3,5-di-tert.-butyl-4-hydroxyphenylpropionic acid and that of Irgaphos 168 is tris(2,4-di-tert.-butylphenyl)phosphite.

The amount in which the additional stabilizers may be present in the moulding compositions according to the invention is variable and is in the range from 0.1 to 5 wt. %, calculated on the total weight of the moulding composition.

Thermoplastic polyolefins which are particularly suitable according to the invention are PE, PP and PB-1 or copolymers of olefins with 2, 3 or 4 C atoms or with further olefinic monomers with 5 to 10 C atoms which may readily be processed into pipes by extrusion.

PE moulding compositions according to the invention have for example a density at a temperature of 23° C. in the range from 0.93 to 0.965 g/cm³ and a melt index MI_{190/5} in the range from 0.1 to 2 g/10 min. Such polyethylene moulding compositions are produced by polymerization of ethylene or copolymerization of ethylene together with other olefinic comonomers in the presence of suitable catalysts such as Ziegler or Phillips catalysts or also metallocene catalysts in suspension or in the gas phase and are also known by the name low-pressure polyethylene or HDPE.

PP moulding compositions according to the invention may for example be high molecular weight homopolymers, random copolymers or block copolymers with a melt index MI_{230/5} in the range from 0.1 to 2 g/10 min.

PB-1 moulding compositions according to the invention may for example be homopolymers or copolymers with a melt index MI_{190/2.16} in the range from 0.1 to 1 g/10 min and a density at a temperature of 23° C. in the range from 0.92 to 0.95 g/cm³.

Beside the thermoplastic polyolefin, the moulding composition according to the invention may contain still further additives. Such additives are preferably heat and processing stabilizers, antioxidants, UV absorbers, light stabilizers, metal deactivators, peroxy-scavenging compounds, organic peroxides, basic co-stabilizers in amounts of 0 to 10 wt. %, preferably of 0 to 5 wt. %, as well as carbon black, fillers, pigments or combinations of these in total quantities of 0 to 30 wt. %, calculated on the total weight of the mixture.

Resistance to thermo-oxidative degradation which is sufficiently good for the purposes of the present invention is expressed by an “OIT” (=oxidation induction time) value, which is determined at a temperature of 200° C. and should be in the range from 10 to 20 min, preferably in the range from 12 to 17 min.

### EXEMPLARY EMBODIMENTS

A high molecular weight, medium density PE powder with a density of 0.946 g/cm³ and a melt flow index MI_{190/5} of 0.3 g/10 min, measured to ISO 1133, was combined with various additive formulations and pelletized on a ZSK 53 extruder from Coperion, Werner & Pfleiderer GmbH & Co KG at a melt temperature of 220° C. The pellets were then converted into sheets and subsequently cut into 2 cm wide strips. The strips were then aged over a period of 200 h in an aqueous solution containing 20 ppm of chlorine dioxide at a temperature of 60° C. and a pH value of 6.5.

The intrinsic viscosity iV to DIN ISO 1628 in units of dl/g and the OIT value (=oxidation induction time) to DIN EN 728 at 200° C., corresponding to ASTM-D 3895, in units of min were then measured on the starting materials and on the aged samples. The results are listed in Table 1 below.

TABLE 1

| | | | State of | iV in dl/g | OIT |
|---|---|---|---|---|---|
| Example | | Amount | matter | before/ | (200° C.) |
| no. | Additive | in % | at 25° C. | after | [min] |
| 1 | comparison, blank | — | — | 3.2/2.4 | <1 |
| | sample | | | | |
| 2 | ETDC¹⁾ | 0.2 | liquid | 3.2/3.2 | 15 |
| | according to the | | | | |
| | invention | | | | |
| 3 | urea, comparison | 0.2 | solid | 3.2/3.0 | 5 |
| 4 | Chimasorb 944 | 0.2 | solid | 3.2/2.6 | <1 |
| | comparison | | | | |
| 5 | Naugard XL-1 | 0.2 | solid | 3.2/2.9 | 6 |
| | comparison | | | | |
| 6 | MD 1024 | 0.2 | solid | 3.2/2.9 | 5 |
| | comparison | | | | |
| 7 | DMPD²⁾ according | 0.2 | liquid | 3.2/3.2 | 14 |
| | to the invention | | | | |
| 8 | Irganox 1010 plus | 0.1 | liquid | 3.2/3.2 | 15 |
| | ETDC | plus | | | |
| | according to the | 0.1 | | | |
| | invention | | | | |
| 9 | Irgaphos 168 plus | 0.1 | liquid | 3.2/3.2 | 14 |
| | DMPD | plus | | | |
| | according to the | 0.1 | | | |
| | invention | | | | |

¹⁾ETDC = 6-ethoxy-2,2,4-trimethyl-1,2-dihydroquinoline
²⁾DMPD = dimethylphenylenediamine

The above-described exemplary embodiments clearly reveal that the best results in stabilizing the polymer matrix against thermo-oxidative degradation are achieved when the liquid amines from Examples 2 and 7 are used.

The Comparative Examples clearly reveal that amino compounds which are in a solid state of matter under standard conditions are only capable of making a substantially lower contribution to stabilization and for this reason are less suitable for the purposes of the stabilization desired according to the invention.

1. A polyolefinic moulding composition, comprising at least one thermoplastic polyolefin and an amount of 0.01 to 1.0 wt. %, calculated on the weight of the thermoplastic polyolefin, of an aromatic amine which is liquid under normal pressure and at temperatures in the range from 0 to 30° C.

2. The polyolefinic moulding composition according to claim 1, wherein the aromatic amine comprises 6-ethoxy-2,2,4-trimethyl-1,2-dihydroquinoline or dimethylphenylenediamine.

3. The polyolefinic moulding composition according to claim 1 wherein the aromatic amine is present in an amount from 0.01 to 0.5 wt. %.

4. The polyolefinic moulding composition according to claim 1 wherein the at least one thermoplastic polyolefin contains polyethylene or polypropylene or copolymers of ethylene and propylene or copolymers of ethylene or propylene with olefinically unsaturated monomers having 4 to 10 C atoms.

5. The polyolefinic moulding composition according to claim 1, further comprising additives selected from heat stabilizers, antioxidants, UV absorbers, light stabilizers, metal deactivators, peroxy-scavenging compounds, or basic co-stabilizers, present in amounts of 0.1 to 10 wt. %.

6. A process for improving the resistance to thermo-oxidative degradation of pipes made of thermoplastic polyolefins which are in extended contact with liquids containing disinfectants with an oxidative action, the process comprising extruding the polyolefinic moulding composition according to claim 1, thereby forming a pipe.

7. A pipe having improved resistance to thermo-oxidative degradation comprising the polyolefinic moulding composition according to claim 1.

8. A process comprising conveying drinking water in a pipe comprising the polyolefinic moulding composition of claim 1.

9. The polyolefinic moulding composition according to claim 3 wherein the aromatic amine is present in an amount from 0.1 to 0.3 wt. %.

10. The polyolefinic moulding composition according to claim 5 wherein the additives are present in amounts from 0.1 to 5 wt. %.
